(19) United States
(12) Patent Application Publication
(10) Pub. No.: US 2010/0233682 A1
(43) Pub. Date: Sep. 16, 2010

(54) FLUID PROCESSING AND VOLUME DETERMINATION SYSTEM

(75) Inventors: Jeroen Pieter Looijen, Eindhoven (NL); Michiel De Jong, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/294,473

(22) PCT Filed: Mar. 23, 2007
(86) PCT No.: PCT/IB2007/051029

§ 371 Date: Sep. 25, 2008

(30) Foreign Application Priority Data
Mar. 29, 2006 (EP) 06111929.3

(51) Int. Cl. C12Q 1/68; F16K 15/00; C12M 1/00; G01N 33/53

(52) U.S. Cl. 435/6; 137/511; 435/287.2; 435/287.1; 435/7.1; 435/7.2

(57) ABSTRACT

A fluid processing system is described having at least two chambers. Each of said chambers is separated in a first and a second part by a flexible membrane, the first part, in use, comprising essentially a gas and the second part, in use comprising essentially a non-gaseous fluid, an inlet and/or an outlet means. One or more channels are provided connecting said second parts of said at least two chambers, wherein at least one of said one or more channels includes a pressure sensitive one-way valve. Further, means for exerting pressure on said first part of at least one of said at least two chambers is provided to allow transfer of a sample liquid.

This invention relates to the field of fluid processing in bio- and medical sciences. In particular, the invention relates to the field of molecular diagnostics, specifically in the area of bacterial detection, in blood treatment and diagnostic or in heart replacement applications.

In medical applications, fluid processing is of great importance. Integrated systems, wherein fluids can be processed through several steps inside one closed cartridge present the advantages of saving time, being user friendly and limiting human intervention and therefore also the risk of cross-contamination. U.S. Pat. No. 5,193,990 describes a system that permits flow control of the fluid flowing out of a main chamber. The main chamber is divided into two regions by a membrane: a first region into and out of which fluid flows and a second region which is filled with a gas. A first level of control is operated by monitoring the pressure changes of the gas in relation to those in a fixed reference volume, as a basis of flow measurement. Boyle's law is used to determine the volume of the second region, and because the combined volume of the first and the second region is constant, the volume of the first region is known. A second level of control is achieved by providing a substantially smaller auxiliary dispensing chamber. The auxiliary dispensing chamber is divided as well into two regions by a membrane so that the volume of its first region is variable between fixed maximum and minimum limits. By filling the auxiliary dispensing chamber to its maximum volume from the main chamber, and by causing thereafter this volume to be reduced over time to its minimum volume, the volume change of the dispensing chamber per unit time is determined. Finally, a third level of control is disclosed wherein the volume of fluid remaining in the dispensing chamber is determined by monitoring the pressure change in the auxiliary chamber in the manner of pressure in the measurement chamber.

The flow control system of the prior art has the disadvantage of requiring the presence of either an additional fixed reference volume connected to the chamber out of which the fluid's flow is wished to be measured or the presence of a smaller auxiliary chamber. These requirements complicate the set-up and increase the bulkiness of the device. The prior art devices also require several valve switching and pumping steps to operate the aforementioned flow control. These render automation difficult and are time consuming.

There is therefore a need in the art for simpler, user-friendlier, faster and more compact systems to do so.

An object of the present invention is the provision of an improved fluid processing system, which permits processing of non-gaseous fluids from one chamber to another within a multi-chamber device and to provide an improved measurement method to determine to which extent a fluid has flowed from one chamber to another within a fluid processing system.

Broadly speaking, the invention is based on the finding that fluid can be efficiently processed from one chamber to another in a controlled way, without using bulky calibration chambers and cumbersome valve systems by using a unique pressure source for both, directing fluids through pressure sensitive one-way valves and gaining accurate information concerning the extent to which each fluid processing step has been performed.

An embodiment of the present invention relates to a fluid processing system comprising at least two chambers. Each of these chambers is separated in a first and a second part by a flexible membrane. In the first part there is essentially a gas such as for instance air, N₂, Ar or the like and in the second part there is essentially a non-gaseous fluid. In each chamber there is an inlet and/or an outlet means. The second parts are connected by one or more channels, at least one of said one or more channels incorporating a pressure sensitive one-way valve. The fluid processing system further comprises means for exerting pressure on the first part of at least one of the at least two chambers.

This embodiment is advantageous because it permits processing of fluid from one chamber to another of a fluid processing system in a minimal number of valve switching and pumping steps and additionally reducing the number of valves which need to be controlled.

As an additional feature, at least one of the first parts of the at least two chambers is connected to a pressure transducer. This is advantageous because it permits to use the pressure changes within the chamber in question to determine directly and precisely the extent to which fluid has been processed to or from this chamber—this, without necessarily requiring an additional reference chamber.

As another additional feature, the means for exerting pressure is a single pressure means connected via a pressure supply line to each of the at least two chambers. The pressure supply line comprises one valve, preferably 3/2 valves, for each of the at least two chambers, permitting to connect or disconnect each of the at least two chambers from the means for exerting pressure. This is advantageous because the use of a single pressure means is economical and permits nevertheless a full control on the fluid delivery of each chamber within the system.

As another additional feature, at least one of the at least two chambers has its second part directly connected to the second parts of two or more other chambers, by one or more channels. At least one of the one or more channels incorporates a pressure sensitive one-way valve. If the at least one of the at least two chambers acts as a receiving chamber and is therefore positioned downstream of the at least two of said two or more other chambers, acting as transferring chambers, this system can be advantageously used to operate mixing of fluids from transferring chambers in the receiving chamber. Another advantage is that the transferring chambers can be used as refill for the receiving chamber. If the at least one of the at least two chambers acts as a transferring chamber, this system can be advantageously used for instance to control the flow of the system or the delivered dose of the fluid by choosing between receiving chambers of different volume. Another additional feature is therefore the use of a multi-position valve to permit by selecting positions thereof, to selectively connect or disconnect the second part of a transferring chamber from/to any of the receiving chambers and yet another additional feature applicable together with any of the embodiments and additional features described above is the use of chambers differing in size.

As another additional feature, a single exhaust line is connecting the first part of all chambers, preferably via the 3/2 valves present in the pressure supply lines. This is advantageous because it permits to centralize the opening or closure of the whole gas circuit and therefore to simplify it. It has the additional advantage to permit the inclusion of a single air reservoir of known volume that would be useable to calibrate the volume of any chamber within the system. An additional feature is therefore the connection of an air reservoir to the exhaust line but one of the advantages of the present invention is that it makes such a reservoir optional.

Another embodiment of the present invention is a method to determine the volume ΔV of a non-gaseous fluid that has been transferred from one chamber to another of known volume V₈ in a fluid processing system according to any of the embodiments and additional feature of the present invention. The method comprises the steps of:

(i) measuring the pressure P₈ in the first part of the receiving chamber before said transfer,

(ii) measuring the pressure P₈′ in the first part of the receiving chamber after said transfer,

(iii) resolving the following equation: ΔV=V₈(1−P₈/P₈′)

This embodiment has the advantage to permit the precise determination of the volume ΔV of a non-gaseous fluid that has been transferred from one chamber to another without using any additional reference chambers.

As an additional feature, step (iii) can be replaced by the following steps:

(i) measuring the temperature T₈ in the first part of the receiving chamber before said transfer,

(ii) measuring the temperature T₈′ in the first part of the receiving chamber after said transfer,

(iii) resolving the following equation: ΔV=V₈′(P₈′T₈/T₈′P₈−1)

This has the advantage to permit to determine even more precisely the volume ΔV of a non-gaseous fluid that has been transferred from one chamber to another in conditions where temperature changes are expected during the processing (e.g. when processing fresh blood).

Another embodiment of the present invention is a biosensing device for the analysis of a fluid containing one or more analyte molecules to be detected, e.g. containing one or more polynucleic acid target molecules, proteins, membrane fragments, cellular fragments or other biomoelcules, etc., said biosensing device comprising:

a fluid processing system comprising:

(i) at least two chambers, each of said chambers being separated in a first and a second part by a flexible membrane, said first part comprising essentially a gas and said second part comprising essentially a non-gaseous fluid, an inlet and/or an outlet means,

(ii) one or more channels connecting said second parts of said at least two chambers, wherein at least one of said one or more channels includes a pressure sensitive one-way valve,

(iii) means for exerting pressure on said first part of at least one of said at least two chambers.

wherein

a) one of the at least two chambers is any of: a PCR amplification chamber (25), a detection chamber (27), e.g. including a biosensing solid substrate (30) comprising one or more probes able to specifically bind to said one or more analyte molecules, e.g. target polynucleic acid molecules, a cell lysing chamber, a purification chamber, a washing chamber, an incubation chamber, a thermal cycling chamber, a cell fragment extraction chamber, e.g. for DNA extraction, or

b) an inlet or an outlet of at least one of the at least two chambers is fluidly connectable to any of: a PCR amplification chamber (25), a detection chamber (27), e.g. including a biosensing solid substrate (30) comprising one or more probes able to specifically bind to said one or more analyte molecules, e.g. target polynucleic acid molecules, a cell lysing chamber, a purification chamber, a washing chamber, an incubation chamber, a thermal cycling chamber, a cell fragment extraction chamber, e.g. for DNA extraction.

Optionally a detector may be provided in one of the chambers for analysing said biosensing substrate after that said sample fluid has contacted said biosensing solid substrate so as to determine the presence of said one or more target analyte molecules. The detector may be an optical detector and a wall of the chamber may be made transparent to allow such an optical detection.

This embodiment has the advantage to enable the control and the measurement of each fluid processing step of a bio sensing device.

The present invention also provides a method of processing a sample liquid, e.g. for analysis of a fluid containing one or more analyte molecules, said method comprising:

processing a sample liquid using at least two chambers, each of said chambers being separated in a first and a second part by a flexible membrane, said first part comprising essentially a gas and said second part comprising essentially a non-gaseous fluid, an inlet and/or an outlet means, one or more channels connecting said second parts of said at least two chambers, wherein at least one of said one or more channels includes a pressure sensitive one-way valve, the method further comprising exerting pressure on said first part of at least one of said at least two chambers to transfer sample liquid. At least one step of the method may include any of: PCR amplification, detection, thermal cycling, cell lysing, cell fragment extraction, washing, purification, and incubation.

The invention will now be described with reference to the following drawings:

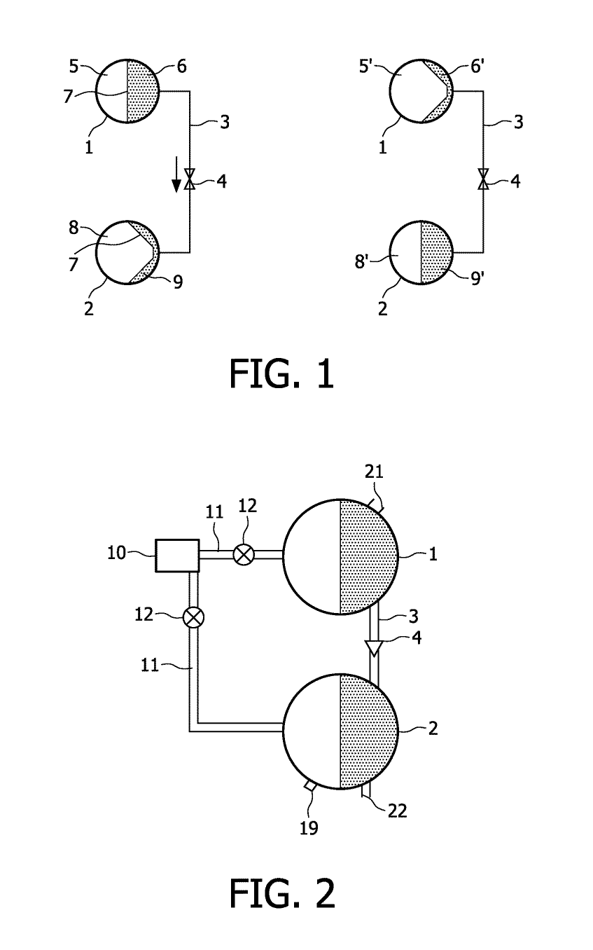

FIG. 1 is a schematic view illustrating a measurement method according to an embodiment of the present invention.

FIG. 2 is a schematic view of a fluid processing system according to one embodiment of the present invention.

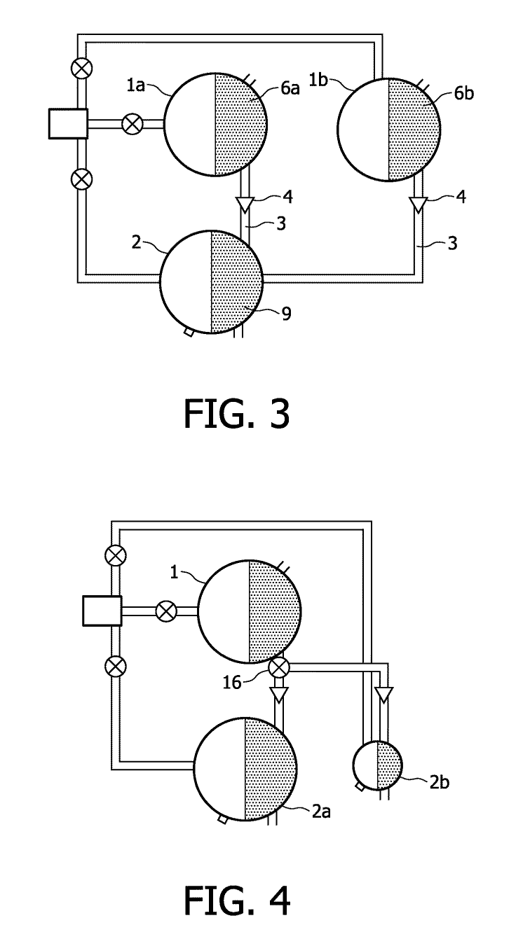

FIG. 3 is a schematic view of a fluid processing system according to one embodiment of the present invention.

FIG. 4 is a schematic view of a fluid processing system according to one embodiment of the present invention.

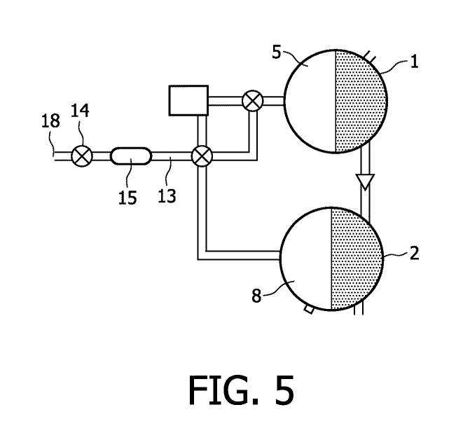

FIG. 5 is a schematic view of a fluid processing system according to one embodiment of the present invention.

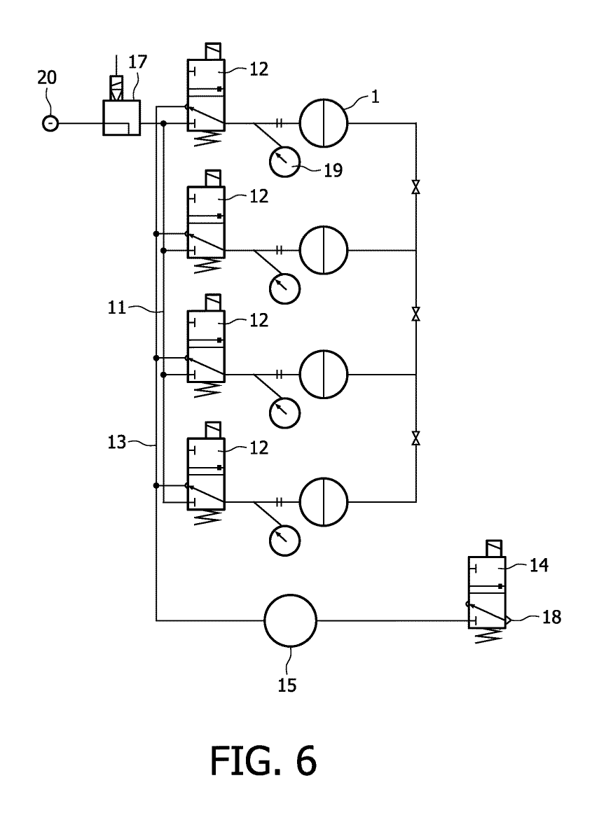

FIG. 6 is a schematic view of a particular example of fluid processing system according to the present invention.

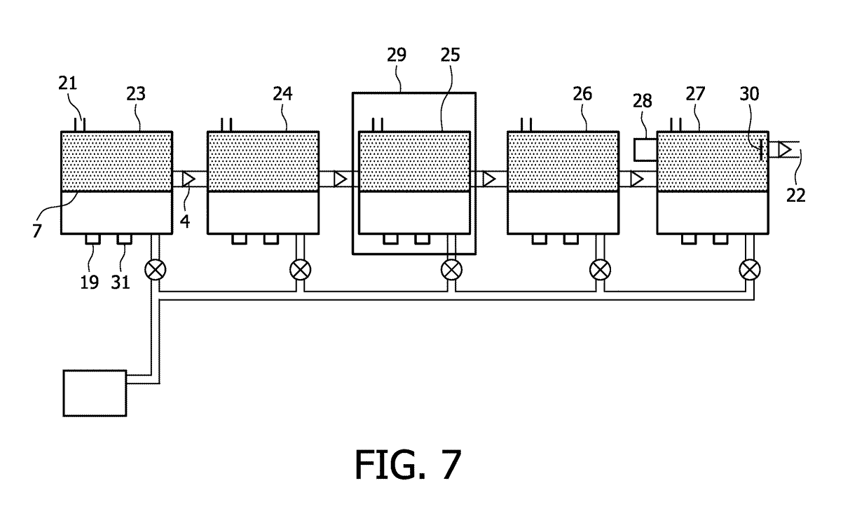

FIG. 7 shows a further embodiment of the present invention namely the application of the flow control device present invention to a biosensing device, for example, for analyzing target polynucleic acid molecules present in a sample fluid.

The present invention will be described with respect to particular embodiments and with reference to certain drawings but the invention is not limited thereto but only by the claims. Any reference signs in the claims shall not be construed as limiting the scope. The drawings described are only schematic and are non-limiting. In the drawings, the size of some of the elements may be exaggerated and not drawn on scale for illustrative purposes. Where the term <<comprising>> is used in the present description and/or claims, it does not exclude the presence of other elements or steps.

Where an indefinite article is used when referring to a singular noun e.g. <<a>>, <<an>> or <<the>>, this includes a plural of that noun unless something else is specifically stated.

Furthermore, the terms first, second, third and the like in the description and/or in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

In one embodiment, the present invention relates to a fluid processing system. The term fluid can be understood as a non-gaseous fluid as far as the fluid is concerned which is to be processed in the system, e.g. delivered from the system. This fluid processing system is composed of at least two chambers from which or toward which fluid can be processed. Each chamber is preferably made from a material of such thickness that pressure changes applied during the operation of the system do not change the volume of the chambers appreciably. The walls of the chambers are therefore rigid and inflexible and made of a solid material. Each chamber of the system is separated into a first and a second part by a membrane. In the first part there is essentially a gas and in the second part essentially a non-gaseous fluid. The second part has inlet means for the introduction of the non-gaseous fluid to be processed or for receiving processed non-gaseous fluid coming from another chamber. Also comprised in the second part is an outlet means for either transferring processed non-gaseous fluids to another chamber or for releasing the fluid to its destination. The connection between the second parts of the at least two chambers are provided by one or more channels and the processing of the fluid from one chamber to another or/and from one chamber to its destination is regulated by valves. These valves may be pressure sensitive valves. In particular between the first and second chamber a one-way valve may be provided. The actuation leading to the processing of a non-gaseous-fluid from one chamber to another is operated by way of means for exerting pressure on the first part of the transferring chamber. The necessary condition for the non-gaseous fluid to be transferred from the transferring chamber to the receiving chamber is the following: the pressure exerted by the pressure means on the gas and therefore also on the non-gaseous fluid and consequently on the pressure sensitive one-way valve in contact with this fluid should be greater than the threshold pressure of the one-way valve and the pressure in the corresponding gas-filled first part of the receiving chamber.

In another embodiment of the present invention, at least one of the first parts of the at least two chambers is connected to a pressure sensitive transducer. Preferably, the pressure transducer is connected to a receiving chamber. This way, the pressure of the gas in the receiving chamber can be monitored. For this purpose the transducer can be connected to monitoring electronics.

In another embodiment of the present invention, the monitoring of the receiving chamber's pressure is used in order to derive the volume of non-gaseous fluid that has been transferred to this receiving chamber. This embodiment is illustrated in FIG. 1.

On the left part of the Figure, two chambers are drawn. The top chamber is the transferring chamber (1) which has a total volume V₁. The bottom chamber is the receiving chamber (2) which has a total volume V₂. Each of the chambers comprises a first part (5) and (8) and a second part (6) and (9), separated by a flexible membrane (7). The first parts (5) and (8) are filled essentially a gas while the second part (6) of the transferring chamber (1) contains essentially a non-gaseous fluid and the second part of the receiving chamber is essentially empty. The first parts (5) and (8) of the chambers can be pressurized externally by means not drawn in this scheme for the sake of clarity. The second parts (6 and 9) are connected by a channel (3). In this channel (3), a valve is provided which is preferably a pressure sensitive one-way valve (4) that opens at a certain minimum pressure. The arrow indicates the flow direction permitted by the pressure sensitive one-way valve. The connecting channel volume is considered to be negligible with respect to the chamber volumes.

Although the use of pressure-sensitive one-way valves permits to reduce the number of valve switching steps, pumping steps and valves to be controlled, the pressure necessary to open or close these valves may change with time, e.g. due to aging. When the volume used for measuring flow rate is dependent upon pressure, this can result in inaccuracies in the measuring and/or control of the flow rate. The system according to the present invention avoids this problem by making the measurement and/or control of the volume of fluid delivered and/or the flow rate independent of the opening or closing pressure of the valve. This method of measurement and/or control is described below.

As a preliminary step, before introducing the fluid to be processed, it is useful to minimize the air content of the second part of all chambers. This preliminary step can be performed by pressurizing all chambers in order to make them completely gas filled, stretching the membranes (7) completely. This way, the air content of the chamber parts for fluids (second parts (6) and (9)) is minimized. The excess air on the second parts of the chambers (6) and (9) is exhausted to the environment via an exhaust line not drawn for the sake of clarity.

After that, a fluid is introduced in the second part (6) of transferring chamber (1), and the following equations are valid:

V₁=V₅+V₆

V₂=V₈+V₉

V₉=0

Where Vₙ is the volume of the chamber or part (n).

In the next step illustrated on the right side of FIG. 1, the non-gaseous fluid present in chamber 1 is pumped to chamber (2) by pressurizing chamber (1). The membrane (7) stretches until all fluid is pumped out of chamber (1). This is valid as long as the pressure exerted is greater than the threshold pressure of the pressure sensitive one-way valve (4) and the pressure of the corresponding first part (8′) of chamber (2).

The increase of pressure in the chamber (2) will stop as soon as the fluid flow stops. At that point, no fluid is left in chamber (1) and V6′=0. The amount of fluid pumped to (9′) is ΔV. The following equations can be derived:

V₆′=0=V₆−ΔV

Therefore ΔV=V₆

V₉′=V₉+ΔV=ΔV

And since V2 remains unchanged

V₂=V₈+V₉=V₈′+V₉′

V₈′=V₂−V₉=V₈−ΔV

The laws of Boyle and Gay-Lussac are valid for the fixed amount of gas in chamber (2), before and after the displacement of the fluid:

If temperature is considered constant, P₈V₈=P₈′V₈′ (where Pₙ is the pressure in part n) and therefore we have:

ΔV=V₈(1−P₈/P₈′)

and the amount of displaced fluid ΔV can be derived when the volume V₈ is known, as well as the two pressures P₈ and P₈′.

An improvement is to connect to the receiving chamber a temperature sensor (not shown on FIG. 1) in addition to the pressure transducer. This permits to take into consideration temperature changes during fluid processing.

If the temperature is taken into consideration:

ΔV=V₈′(P₈′T₈/T₈′P₈−1)

FIG. 2 exemplifies another embodiment of the present invention wherein only two chambers (1) and (2) are represented for the sake of clarity. The second parts of these two chambers are linked by a channel (3) including a one-way valve (4). The first part of receiving chamber (2) comprises a pressure transducer (19) and its second part comprises an outlet means (22). The second part of the first chamber (1) comprises an inlet means (21). In this embodiment, the means for exerting pressure is a single pressure means (10) connected via pressure supply lines (11) to each of the two chambers (1) and (2). The pressure supply lines (11) comprise one valve (12) per chamber in order to individually allow the connection or disconnection of each chamber from the means for exerting pressure (10). Another embodiment of the present invention is exemplified in FIG. 3 where three chambers are represented. Chamber (1a) and (1b) act as transferring chambers and chamber (2), positioned downstream relatively to chambers (1a) and (1b) acts as a receiving chamber. Chamber (2) has its second part (9) directly connected to the second parts (6a) and (6b) of the two other chambers (1a) and (1b) by channels (3). In this example, the two channels depicted are both equipped with a pressure sensitive one-way valve (4).

Another embodiment of the present invention is exemplified in FIG. 4 where three chambers are represented. Chamber (1) acts as a transferring chamber and is positioned upstream relatively to chambers (2a) and (2b). A valve (16) permits to connect or disconnect selectively the second part of chamber 1 from/to any of the two other chambers. The smaller size of chamber (2b) is there to illustrate that the sizes of the various chambers used in any of the embodiments of the present invention are not necessarily equal to each other.

FIG. 5 shows an embodiment of the present invention wherein the first parts (5) and (8) of all chambers (1) and (2) are connected to an exhaust line (13) via 3/2 valves. 3/2 valves are valves, preferably pneumatic valves, that have three connections and two positions. Here, a first connection leads to the pressure supply line (11), a second connection leads to a chamber (1) or (2) and a third connections leads to the exhaust line. Chamber (1) or (2) can therefore be connected to either the supply line or the exhaust line. The exhaust line (13) is opened or closed to the environment (18) depending on the position of a terminal valve (14). An optional air reservoir (15) is represented connected to the exhaust line (13). This optional air reservoir (15) has a known volume and can be useful to calibrate, in the way described in U.S. Pat. No. 5,193,990, any of the chambers (1) or (2) connected thereto.

FIG. 6 shows a specific example illustrating an embodiment of the present invention. In this example, four chambers (1) are interconnected. The supply and exhaust of the fluid channels are not drawn for the sake of clarity. The switching of a 3/2 valve (12) can pressurize each chamber (1). The pneumatic supply (20) is connected to one shared pressure supply line (11) that supplies air with a pressure, controlled by the electronic pressure regulator (17) to each 3/2 valves (12). In FIG. 6, each 3/2 valve (12) is closed and every chamber (1) is connected to a shared exhaust line (13). The exhaust line (13) contains an air reservoir (15). The flow in the exhaust line (13) towards the environment (18) is interrupted by an exhaust valve (14). The exhaust line (13) is open, only when this valve (14) is open. When the exhaust line (13) is closed, the volume of air in the exhaust line (13), the air reservoir (15) and the connected chambers (1) is fixed. This way, the measurement method described above can be used to determine the amount of fluid flowing into an arbitrary chamber (1). This is valid if this chamber (1) is not pressurized at that time and the exhaust valve (14) is closed. Interpretation of the pressure measurement by the associated pressure transducer (19) is dependant on the measurement volume, which is not only the original volume of the chamber (1) but which includes the exhaust line (13), the air reservoir (15) and the linked chamber volume (1).

FIG. 7 shows the application of the present invention to a biosensing device, e.g. for detecting the presence of, either quantitatively or qualitatively, of an analyte in a sample liquid. The analyte may be any analyte molecule useful in molecular diagnostics such as DNA, RNA, protein, an enzyme, a carbohydrate, a cell, cell fragments, membrane fragments, soluble or bound receptors, a circulating blood marker, e.g. a tumor marker, an antibody, etc. For example the biosensor may be used for analyzing target polynucleic acid molecules present in a sample fluid. This biosensing device is composed of two or more chambers. One of the chambers may be any of: a PCR amplification chamber (25) (e.g. enclosed within a thermal cycler (29)), a detection chamber (27), e.g. containing a biosensing substrate (30) and coupled to a detector (28), a thermal cycling chamber, a cell lysing chamber, a cell fragment extraction chamber such as a DNA or cell membrane or cell receptor extraction chamber, a washing chamber, a purification chamber, an incubation chamber, etc. Further chambers are included within the scope of the present invention. The chambers may be arranged in any suitable fluidly connectable order. For example, a lysing chamber (23) and/or a nucleic acid extraction chamber (24) can be added upstream of the PCR amplification chamber (25) and a purification chamber (26) can be added between the PCR amplification chamber (25) and the detection chamber (27). The chamber situated upstream of all other chambers has an inlet means (21) for receiving a fluid to be analyzed. All chambers optionally have an inlet means (21) for receiving the necessary reactants and/or enzymes and/or solvents and/or buffers, a pressure transducer (19) and a temperature sensor (31).

The fluid processing embodiments of the present invention described above may be used with the series of chambers shown in FIG. 7 in variety of ways. Firstly, the an inlet and/or and outlet of at least one of the at least two chambers of the fluid processing arrangement according to the present invention may be fluidly connected or fluidly connectable, e.g. via selectable and controllable valves, to one or more of the processing chambers mentioned above, namely a PCR amplification chamber (25) (e.g. enclosed within a thermal cycler (29)), a detection chamber (27), e.g. containing a biosensing substrate (30) and coupled to a detector (28), a thermal cycling chamber, a cell lysing chamber, a cell fragment extraction chamber such as a DNA or cell membrane or cell receptor extraction chamber, a washing chamber, a purification chamber, an incubation chamber, etc. The fluid processing arrangement of the present invention can be used to deliver reagents, solutions such as washing solutions, sample liquids, etc. in a dosed manner to any of these chambers or to remove reagents, solutions such as washing solutions, sample liquids, etc., from any of these chambers in a dosed manner. The two chamber fluid processing arrangement according to the present invention may also be connected or connectable, e.g. via selectable and controllable valves, to sources of fluids such as reagents, solutions such as washing solutions, sample liquids, etc., in order for these to be dispensed in a controlled manner to any of the processing chambers.

In another embodiment of the present invention, the at least two chamber fluid processing arrangement of the present invention may be integrated with processing chambers of the type described above. Returning to FIG. 7, in the optional lysing chamber (23), the cells present in the fluid are lysed (e.g. by osmotic, mechanic or enzymatic means). Once the lysis performed, the fluid is processed to the next chamber by applying pressure on the first part of chamber (23). In FIG. 7, the next chamber is the optional extraction chamber (24). In the optional extraction chamber (24), polynucleic acid (e.g. DNA or RNA) is separated from the non-nucleic materials (e.g. by using chemical, solvent extraction, precipitation or centrifugation means). Once this separation performed, the fluid is processed to the next chamber by applying pressure on the first part of chamber (24). The next chamber is the PCR amplification chamber (25). In the PCR amplification chamber (25), the polynucleic acid fragment of interest is recognized by a chosen tagged primer and amplified by a standard PCR thermal procedure well known to the person skilled in art. The thermal procedure is carried on by the thermal cycler (29). In FIG. 7, the next chamber is the optical purification chamber (26). In the optional purification chamber (26), free primers and other reaction contaminants remaining after the PCR step can be removed (e.g. via interaction with silica). Once this purification performed, the fluid is processed to the next chamber by applying pressure on the first part of chamber (26). The next and last chamber is the detection chamber (27). In the detection chamber (27), the amplified (and optionally purified) polynucleic acid fragment is hybridized on one or more specific probes presents on a biosensing solid substrate (30). Once the hybridization has been performed, the non-hybridized polynucleic acid fragments are expelled at the outlet (22) by applying pressure on the first part of chamber (27). In a last step, the hybridized polynucleic acid is detected via its tagged primer (e.g. a primer tagged with a marker such as but not limited to a fluorescent marker) by a detector (e.g. an optical detector (28)).

The term <<probe>> designates an agent, immobilized onto the surface of the biosensing solid substrate and/or into the substrate, being capable of some specific interaction with the target polynucleic acid that is part of the sample when put in the presence of or reacted with said target polynucleic acid, and used in order to detect the presence of said target polynucleic acid. Probes include molecular compounds such as, but not limited to, nucleic acids and related compounds (e.g. DNAs, RNAs, oligonucleotides or analogs thereof, PCR products, genomic DNA, bacterial artificial chromosomes, plasmids and the like).

The term <<marker>> designates an agent, which is readily detectable by suitable means so as to enable the detection of its physical distribution and/or the intensity of the signal delivered such as, but not limited to, luminescent molecules (e.g. fluorescent agent, phosphorescent agent, chemiluminescent agents, bioluminescent agents and the like), colored molecules, molecules producing colors upon reaction, enzymes, magnetic beads, radioisotopes, specifically bindable ligands, microbubbles detectable by sonic resonance and the like.

As used herein, and unless stated otherwise, the term <<tag>> designates the action of bringing a label in the presence of a probe, or linking or interacting (e.g. reacting) a label with a probe.

The nature of the non-gaseous fluid is not critical for the present invention and any non-gaseous fluid can be considered. Particular examples of fluids that can be processed in the system of the present invention are bio-fluids (i.e. fluids of biological nature such as but not limited to blood, sputum, sperm, saliva, urine, sweat, milk, bile, cerebrospinal fluid, blister fluid, serum or cyst fluid and the likes). Although the present invention is particularly interesting for use in biological and medical applications, the invention does not limits itself to these areas and can be used in domain such as analytical or organic chemistry among others. Fluids used in these applications form therefore another class of fluids that can be used in the present invention. The shape of the chambers is not critical for the present invention and any shapes, even very complex ones may be considered. The important feature concerning the chambers is that their volume should be fixed, i.e. the chambers should be rigid. The membrane used in the present invention must be both gas and non-gaseous fluid tight. It must be chosen in order to be inert toward the gas and the non-gaseous fluid used. A requirement for the membrane is that this membrane should be flexible and elastic so that it can extend reversibly the volume of both chamber parts to reach volumes at or close to the maximum volume of the chamber. The membrane is therefore preferably elastic. Suitable membrane compositions include but are not limited to thermoplastic polymers (such as but not limited to poly(ethylene), poly(propylene), polyamides, poly(vinylchloride) and the likes), elastomers (such as but not limited to natural rubber, polybutadiene, polyisoprene, ethylene propylene rubber, silicone and the likes) and thermoplastic elastomers (such as but not limited to poly(styrene-butadiene-styrene).

The gas used can be virtually any gas chemically compatible with the membrane. Useful gases are those which are safe, readily available and cheap. Examples includes but are not limited to air, N₂, Ar and the likes.

1. A fluid processing system comprising:
(i) at least two chambers, each of said chambers being separated in a first and a second part by a flexible membrane, said first part comprising essentially a gas and said second part comprising essentially a non-gaseous fluid, an inlet and/or an outlet means,
(ii) one or more channels connecting said second parts of said at least two chambers, wherein at least one of said one or more channels includes a pressure sensitive one-way valve,
(iii) means for exerting pressure on said first part of at least one of said at least two chambers.

2. A fluid processing system according to claim 1 wherein at least one of the said first parts of said at least two chambers is connected to a pressure transducer.

3. A fluid processing system according to claim 1 wherein at least one of the said first parts of said at least two chambers is connected to a temperature sensor.

4. A fluid processing system according to claim 1 wherein said means for exerting pressure is a single pressure means connected via a pressure supply line to each of the at least two chambers, said pressure supply lines comprising one valve for each of said at least two chambers, permitting to connect or disconnect said each of said at least two chambers from said means for exerting pressure.

5. A fluid processing system according to claim 4, wherein said one valve for each of said at least two chambers is a 3/2 valve.

6. A fluid processing system according to claim 1 wherein at least one of said at least two chambers has its said second part directly connected to two or more chambers by one or more channels, wherein at least one of said one or more channels incorporates a pressure sensitive one-way valve.

7. A fluid processing system according to claims 6 wherein said at least one of said at least two chambers is positioned downstream of at least two of said two or more chambers.

8. A fluid processing system according to claim 6 wherein said at least one of said at least two chambers is positioned upstream of at least two of said two or more chambers.

9. A fluid processing system according to claim 5 further comprising an exhaust line connecting the first part of all chambers via said 3/2 valves.

10. A fluid processing system according to claim 9, wherein said exhaust line does not comprises an air reservoir.

11. A fluid processing system according to claim 9 further comprising an air reservoir connected to said exhaust line.

12. A fluid processing system according to claim 6 wherein said at least one of said at least two chambers can selectively connect or disconnect its said second part from/to any of said two or more chambers by selecting positions of a multi-position valve.

13. A fluid processing system according to claim 1 wherein two or more of said at least two chambers differ in size.

14. A method to determine the volume ΔV of a non-gaseous fluid that has been transferred from one chamber to another chamber of known volume V8 in a fluid processing system according to claim 1, said method comprising the steps of:
(i) measuring the pressure P8 in the first part of the receiving chamber before said transfer,
(ii) measuring the pressure P8′ in the first part of the receiving chamber after said transfer,
(iii) resolving the following equation: ΔV=V8(1−P8/P8′)

15. A method according to claim 14 comprising instead of step (iii) thereto, the steps of:
(i) measuring the temperature T8 in the first part of the receiving chamber before said transfer,
(ii) measuring the temperature T8′ in the first part of the receiving chamber after said transfer, (iii) resolving the following equation: ΔV=V8′(P8′T8/T8′P8−1).

16. A biosensing device for the analysis of a fluid containing one or more analyte molecules to be detected, said biosensing device comprising:
a fluid processing system comprising:
(i) at least two chambers, each of said chambers being separated in a first and a second part by a flexible membrane, said first part comprising essentially a gas and said second part comprising essentially a non-gaseous fluid, an inlet and/or an outlet means,
(ii) one or more channels connecting said second parts of said at least two chambers, wherein at least one of said one or more channels includes a pressure sensitive one-way valve,
(iii) means for exerting pressure on said first part of at least one of said at least two chambers,
wherein
a) one of the at least two chambers is any of: a PCR amplification chamber (25), a detection chamber (27), a cell lysing chamber, a purification chamber, a washing chamber, an incubation chamber, a thermal cycling chamber, a cell fragment extraction chamber, or
b) an inlet or an outlet of at least one of the at least two chambers is fluidly connectable to any of: a PCR amplification chamber (25), a detection chamber (27), a cell lysing chamber, a purification chamber, a washing chamber, an incubation chamber, a thermal cycling chamber, a cell fragment extraction chamber.

17. The biosensing device according to claim 16, the detection chamber including a biosensing solid substrate (30) comprising one or more probes able to specifically bind said one or more analyte molecules.

18. The biosensing device of claim 17, further comprising a detector for analyzing said biosensing substrate after that said sample fluid has contacted said biosensing solid substrate so as to determine the presence of said one or more analyte molecules.

19. A method of processing a sample liquid, said method comprising:
processing the sample liquid using at least two chambers, each of said chambers being separated in a first and a second part by a flexible membrane, said first part comprising essentially a gas and said second part comprising essentially a non-gaseous fluid, an inlet and/or an outlet means, one or more channels connecting said second parts of said at least two chambers, wherein at least one of said one or more channels includes a pressure sensitive one-way valve, the method further comprising exerting pressure on said first part of at least one of said at least two chambers to transfer sample liquid.

20. The method of claim 19, the method being for analysis of a sample liquid containing one or more analyte molecules, at least a step of the method being any of: PCR amplification, detection, thermal cycling, cell lysing, cell fragment extraction, washing, purification, and incubation.
